(19) United States
(12) Patent Application Publication
(10) Pub. No.: US 2018/0056785 A1
(43) Pub. Date: Mar. 1, 2018

(54) VEHICLE HEAD UNIT SYSTEM

(71) Applicant: JET OPTOELECTRONICS CO., LTD., Taipei City (TW)

(72) Inventors: CHIA-YU LIN, Taipei City (TW); TAI-HAO WEN, Taipei City (TW)

(21) Appl. No.: 15/244,259

(22) Filed: Aug. 23, 2016

(51) Int. Cl. B60K 35/00; G06F 3/041

(52) U.S. Cl. CPC B60K 35/00; B60K 2350/948; B60K 2350/1028; G06F 3/041

(57) ABSTRACT

A vehicle head unit system includes a head unit, an operating panel and a transferring unit. The head unit has a receiving hole. The operating panel has an operating surface and a back surface opposite to the operating surface. The transferring unit has a first end and a second end. The first end is connected to the back surface of the operating panel. The second end is received in the receiving hole of the head unit, and the second end can be detached from the receiving hole of the head unit. Therefore, the operating panel and the head unit can be attached to each other and can be detached from each other.

### BACKGROUND OF THE INVENTION

### 1. Field of the Invention

The instant disclosure relates to a vehicle head unit system; in particular, to a head unit system that is installed in a vehicle, which has a detachable control touch panel.

### 2. Description of Related Art

More and more vehicles are equipped with a vehicle head unit, and the vehicle head unit has a touch panel, so as to provide a more convenient and instinctive way to operate the vehicle head unit. However, the touch panel is usually fixed in the vehicle, making it hard to update the software of the vehicle head unit. The functions and performance of the vehicle head unit are limited. To enhance the functions of the vehicle head unit, the whole vehicle head unit needs to be replaced, and the cost is very expensive. Moreover, the touch panel cannot be used independently.

### SUMMARY OF THE INVENTION

The instant disclosure provides a vehicle head unit system equipped with a detachable control touch panel for solving the problem of the touch panel fixed on the vehicle head unit, which causes the functions and performance of the vehicle head unit to be limited and not easily updated.

To achieve the above-mentioned subject, according to an embodiment of the instant disclosure, a vehicle head unit system is provided, which includes a head unit with a receiving hole, a control touch panel and a transferring unit. The control touch panel has an operating surface and a back side opposite to the operating surface. The transferring unit has a first end and a second end. The first end is connected to the back side of the control touch panel, and the second end is detachably received in the receiving hole of the head unit.

The instant disclosure has at least the effective results as follows. The vehicle head unit system provided by the instant disclosure can have many types of transferring unit. The control touch panel is mounted to the head unit of the vehicle in a detachable manner for providing an operating interface. The operating system and software can be updated conveniently by replacing the old control touch panel with a new, more powerful one. The control touch panel can be separated from the head unit and used independently.

For further understanding of the instant disclosure, please refer to the following detailed description illustrating the embodiments of the instant disclosure. The description is only for illustrating the instant disclosure, not for limiting the scope of the claim.

### BRIEF DESCRIPTION OF THE DRAWINGS

Embodiments are illustrated by way of example and not by way of limitation in the figures of the accompanying drawings, in which like references indicate similar elements and in which:

FIG. 1 shows an exploded perspective view of a vehicle head unit system of a first embodiment of the instant disclosure.

FIG. 2 shows an assembled perspective view of the vehicle head unit system of the first embodiment of the instant disclosure.

FIG. 2A shows another assembled perspective view of the vehicle head unit system of the first embodiment of the instant disclosure.

FIG. 3 shows a side view of the vehicle head unit system of the first embodiment of the instant disclosure.

FIG. 4 shows a side view of a transferring unit supporting a control touch panel of the first embodiment of the instant disclosure.

FIG. 5 shows an exploded perspective view of a vehicle head unit of a second embodiment of the instant disclosure.

FIG. 6 shows a rear view of a control touch panel of the vehicle head unit of the second embodiment of the instant disclosure.

FIG. 7 shows an exploded perspective view of a vehicle head unit of a third embodiment of the instant disclosure.

FIG. 8 shows a rear view of a control touch panel of the vehicle head unit of the third embodiment of the instant disclosure.

FIG. 9 shows a perspective view of the vehicle head unit of the third embodiment having another connecting interface of the instant disclosure.

### DETAILED DESCRIPTION OF PREFERRED EMBODIMENTS

The aforementioned illustrations and the following detailed descriptions are exemplary for the purpose of further explaining the scope of the instant disclosure. Other objectives and advantages related to the instant disclosure will be illustrated in the subsequent descriptions and appended drawings.

### First Embodiment

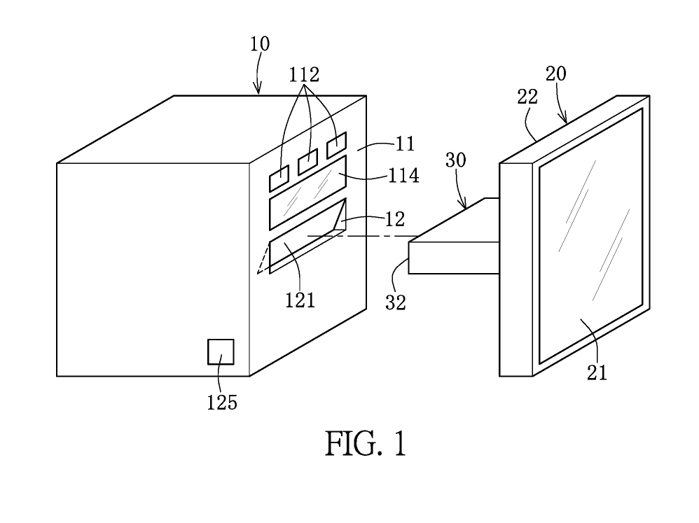

Please refer to FIG. 1 to FIG. 3, which show an exploded perspective view, an assembled perspective view and a side view of a vehicle head unit system according to the instant disclosure. This instant disclosure provides a vehicle head unit system, which includes a head unit 10, a control touch panel 20, and a transferring unit 30. The head unit 10 (sometimes referred to as an automobile deck) can be used to control the vehicle's entertainment media, such as radio broadcasts and music in a media memory device (such as Compact Disk, memory card, etc.), and provides electricity to the control touch panel 20. In this embodiment, the head unit 10 has a front surface 11. The front surface 11 can be equipped with at least one button 112 and a monitor 114, like the conventional control touch panel of the vehicle head unit. The head unit 10 further has a receiving hole 12. The receiving hole 12 is concave inward from the front surface 11. In addition, a preferable embodiment can be equipped with a revolving door 121, which is rotatable and covers the receiving hole 12. The revolving door 121 can be a thin piece of material connected by a hinge, a sliding door, a brush-type door screen, or a key-activated door, which has a beautiful appearance and an anti-dust function.

The control touch panel 20 is a portable device. For example, the control touch panel 20 can be a tablet computer or smart phone, having an operating system, being able to install APPs (applications), equipped with an electrical connector, wireless antenna, and global positioning system hardware (GPS hardware). The control touch panel 20 has an operating surface 21, and a back side 22 opposite to the operating surface 21.

As shown in FIG. 1, one characteristic of the instant disclosure is that, by the transferring unit 30, the control touch panel 20 can be attached to the head unit 10 or detached from the head unit 10. In this embodiment, the transferring unit 30 can be shaped like a board. The transferring unit 30 has a first end 31 and a second end 32. The first end 31 is connected to the back side 22 of the control touch panel 20, and the second end 32 is detachably inserted into the receiving hole 12 of the head unit 10, so that the control touch panel 20 can be attached to the head unit 10. The revolving door 121 is a door connected by a hinge covering the receiving hole 12. The revolving door 121 is closed when the control touch panel 20 is not attached to the head unit 10. When the control touch panel 20 is attached to the head unit 10, the second end 32 of the transferring unit 30 is inserted into the receiving hole 12, and the transferring unit 30 can push away the revolving door 121. The second end 32 of the transferring unit 30 is connected to the head unit 10. When the control touch panel 20 is separated from the head unit 10, the revolving door 121 automatically goes back to the closed position.

The control touch panel 20 can provide the head unit 10 with a graphical operating interface and extend the functions of the head unit 10. In this embodiment, the front surface 11 of the head unit 10 has several buttons 112 and a monitor 114, which can be used to execute the functions of the head unit 10. The buttons 112 and the monitor 114 in FIG. 1 are only illustrated as an example in this embodiment, and the structure of the head unit 10 is not limited thereto. When the control touch panel 20 of this embodiment is dismounted, the head unit 10 can still be operated by the buttons 112 and the monitor 114.

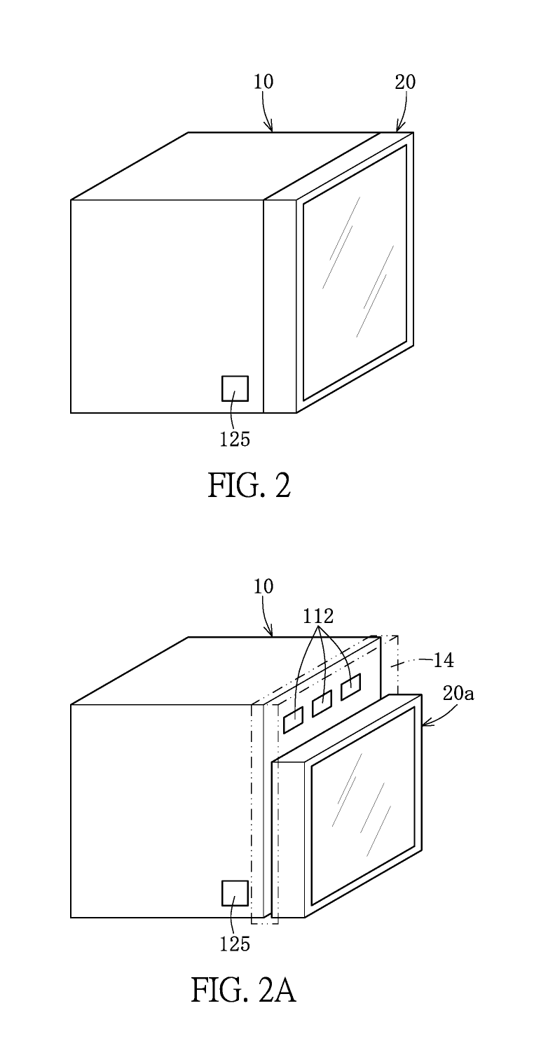

As shown in FIG. 2, when the control touch panel 20 is attached to the head unit 10 by the transferring unit 30, the control touch panel 20 can cover a plurality of buttons 112 of the head unit 10. When the control touch panel 20 is dismounted from the head unit 10, the head unit 10 still can be operated independently, and the control touch panel 20 also can be operated independently. However, this instant disclosure is not limited thereto, for example the control touch panel does not wholly cover the head unit, an example of which is described as follows.

As shown in FIG. 2A, the control touch panel 20a only covers a part of the head unit 10 such as a monitor 114, and the buttons 112 are exposed, so that a user can operate the head unit 10 by the button 112 as well as the control touch panel. In addition, in this embodiment, the control touch panel 20a is not touching the head unit 10 and a gap remains. In this embodiment, a preferable arrangement provides a shelter 14 to cover the gap between the control touch panel 20a and the head unit 10 for aesthetic reasons. In other words, when the control touch panel 20a is attached to the head unit 10, it can wholly cover the front surface 11, or partially cover the front surface 11, or cover none of the front surface 11. When the buttons 112 or the monitor 114 of the front surface 11 are exposed, they can keep their original functions, or they can lose their functions, or their functions can be changed. In addition, when the control touch panel 20a is attached to the head unit 10, it can keep a gap or have no gap between the control touch panel 20a and the head unit 10. When there is a gap, the gap may or may not be covered by the shelter 14. Such variables are determined by the actual design of the system.

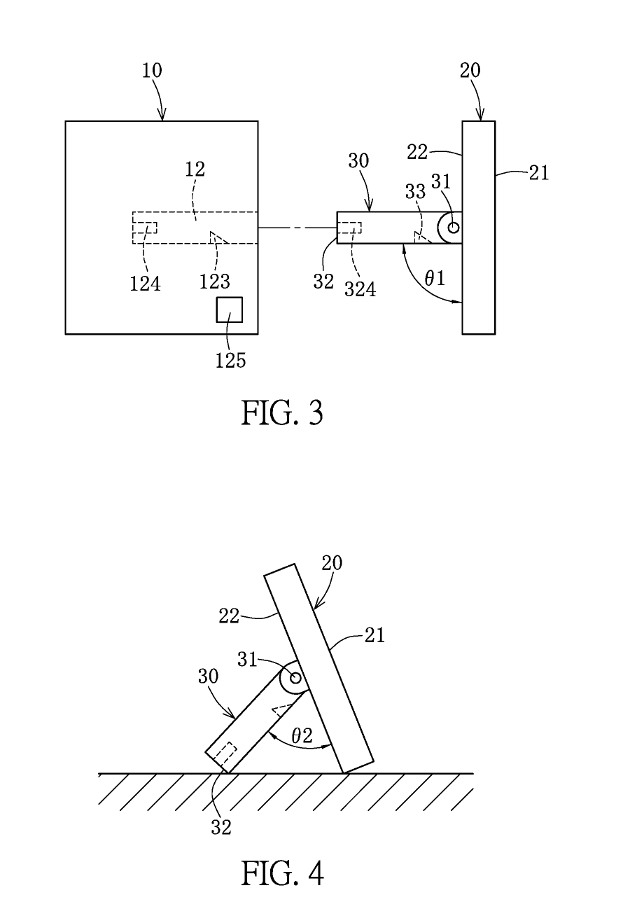

In this embodiment, the first end 31 of the transferring unit 30 can be connected to the back side 22 of the control touch panel 20 by a rotatable means (such as a hinge), a fixing means (such as screws), or other means. The transferring unit 30 is connected to the back side 22 of the control touch panel 20 at an assembling angle θ1, which is adjustable, so that the control touch panel 20 can be attached to the head unit 10. As shown in FIG. 3, the transferring unit 30 and the control touch panel 20 are about perpendicular to each other, and the assembling angle θ1 is about 90 degrees.

FIG. 4 is a side view of a transferring unit supporting a control touch panel of a first embodiment of the instant disclosure. When the control touch panel 20 is taken away from the head unit 10 of the vehicle, the transferring unit 30 is connected to the back side 22 of the control touch panel 20 at a supporting angle θ2, which is adjustable, so as to support the control touch panel 20 on a plane to be used independently. The supporting angle θ2 can be adjusted to a small or a big angle, which can be determined according to the connecting manner of the first end 31 and the back side 22 or the requirements of a user.

In FIG. 3, the head unit 10 has an electrical connector 124 disposed in the receiving hole 12, the second end 32 of the transferring unit 30 has an electrical connector 324. The first end 31 of the transferring unit 30 is electrically connected to the control touch panel 20. The electrical connector 324 of the transferring unit 30 is electrically coupled with the electrical connector 124 of the head unit 10. The electrical connector 124 has power terminals and signal terminals, which can transfer power and signals of the head unit 10 to the control touch panel 20 by the electrical connector 324.

Moreover, the first end 31 of the transferring unit 30 can be designed to connect with the control touch panel 20 in a detachable manner. That is, the control touch panel 20 can be separated from the transferring unit 30. In addition, the electrical connector 324 can be electrically connected to the control touch panel 20 by the first end 31 of the transferring unit 30, such as by a cable, electrical connector, or electrical contact.

In this embodiment, the transferring unit 30 and the control touch panel 20 can be fixed to the head unit 10 by the force provided when the electrical connector 324 is coupled to the electrical connector 124. However, this instant disclosure is not limited thereto.

Refer to FIG. 3. To provide a stronger fixing force, in this embodiment, the head unit 10 has a fixing part 123 in the receiving hole 12. The transferring unit 30 has an anti-eject unit 33 and is fixed in the receiving hole 12 when the fixing part 123 and the anti-eject unit 33 mate. The anti-eject unit 33 is locked in the fixing part 123. The anti-eject unit 33 can be a cavity formed on the transferring unit 30. The fixing part 123 can be a retractable hook. The anti-eject unit 33 and the fixing part 123 can increase the fixing force between the control touch panel 20 and the head unit 10 to prevent an accidental ejection. To achieve this objective, the position of the anti-eject unit 33 and that of the fixing part 123 can be adjusted according to the actual conditions, such as the anti-eject unit 33 and the fixing part 123 can be disposed on the front surface 11 of the head unit 10 and the back side 22 of the control touch panel 20.

In addition, the head unit 10 can further include an eject button 125 which, when pressed, retracts the fixing part 123 so that the anti-eject unit 33 and the fixing part 123 are separated. Thus, user can exert force to remove the control touch panel 20 from the head unit 10. This instant disclosure is not limited by this enhancement method; for example, the anti-eject unit and the fixing part can be exchanged, which also can provide an anti-eject effect. The anti-eject unit and the fixing part also can be installed on any side of the transferring unit 30, the front surface 11, or the back side 22 as long as the anti-eject unit and the fixing part work together to provide the anti-eject effect. In addition, the eject button 125 may not be a button; it could be a switch, such as tact switch, toggle switch, rocker switch, slide switch, etc. The eject button can be a touch button on the control touch panel 20 (such as “homepage”->“setup”->“eject” on the control touch panel), which communicates with the head unit 10 via the control touch panel 20 to retract the fixing part 123 to separate the control touch panel 20 from the head unit 10. Moreover, the ways of separating the control touch panel 20 and the head unit 10 are not limited thereto. For example, a push-push mechanism for ejecting can be used. That is, in the first push, the control touch panel 20 and the transferring unit 30 are fixed in the head unit 10. In the second push, the control touch panel 20 and the transferring unit 30 are ejected from the head unit 10. Here is another example: After pressing the eject button 125, the control touch panel 20 automatically separates from the head unit 10, and the control touch panel 20 moves back a distance toward the user for the user to exert a force to take the control touch panel 20 out.

Even if there is no anti-eject mechanism, the head unit 10 can still have an eject button 125. When the control touch panel 20 is attached to the head unit 10, a user can press the eject button 125, and then the control touch panel 20 is slightly ejected toward the user. Thereafter, the user can exert a force to take the control touch panel 20 out.

Even if there is no anti-eject mechanism, the head unit 10 could be designed without an eject button 125. In such a case, after the control touch panel 20 is attached to the head unit 10, a user can directly exert a force to pull the control touch panel 20 from the head unit 10.

Note that the shapes of the transferring unit 30 and the receiving hole 12 are not limited to those shown in the figures of this instant disclosure.

In addition, a part or both the buttons 112 and the monitor 114 on the front surface 11 can be omitted.

### Second Embodiment

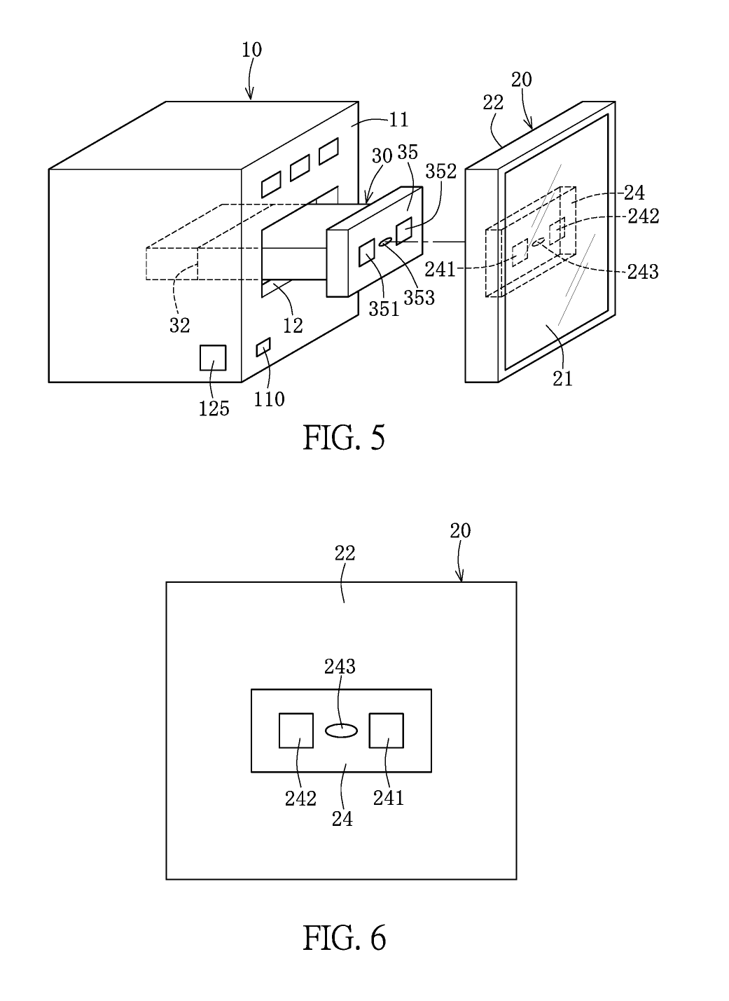

FIG. 5 is a perspective view of the vehicle head unit system of a second embodiment of this instant disclosure, and FIG. 6 is a rear view of the control touch panel. This embodiment is different from the above embodiment in that this embodiment uses magnetic force. The first end of the transferring unit 30 is magnetically attached to the back side 22 of the control touch panel 20. The second end is received in the head unit 10. The transferring unit 30 has a first magnetic module 35, and the first magnetic module 35 has a pair of first magnetic portions 351, 352. The back side 22 of the control touch panel 20 has a second magnetic module 24. The second magnetic module 24 has a pair of second magnetic portions 241, 242. The first magnetic portions 351, 352 and the second magnetic portions 241, 242 may provide magnetic force only, or may provide magnetic force, electricity, and signal transmission simultaneously.

When the control touch panel 20 is not attached to the head unit 10, many conditions are possible. In the first example, the initial position of the transferring unit 30 does not allow the user to combine the control touch panel 20 with the head unit 10. In such a condition, the user needs to extend the transferring unit 30, or use a button or switch of the head unit 10 so that the transferring unit 30 can be extended out and the user can put the control touch panel 20 on the transferring unit 30. In the second example, the initial position of the transferring unit 30 allows a user to combine the control touch panel 20 with the head unit 10. In such a condition, the user can directly put the control touch panel 20 on the transferring unit 30. In the third case, the front surface 11 of the head unit 10 has a detector 110. When the control touch panel 20 is detected by the detector 110, the transferring unit 30 is activated and moved to a position allowing the user to attach the control touch panel 20 to the transferring unit 30. The detector 110 can be at a different place such as on the transferring unit 30.

Concerning the ways of attaching the control touch panel 20 to the head unit 10 in this embodiment, more examples are given as follows. In one condition using common magnets, as the control touch panel 20 is put on the transferring unit 30, the control touch panel 20 can be fixed to the head unit 10 by magnetic force between the first magnetic module 35 and the second magnetic module 24. In another condition using electromagnets, if the head unit 10 has a detector 110, as the control touch panel 20 approaches the detector 110 and the detector 110 detects the control touch panel 20, the electromagnet is electrified automatically, and the user can join the control touch panel 20 to the transferring unit 30. In the condition of an electromagnet and the head unit 10 without having a detector 110, the user can manually operate the head unit 10 to power the electromagnet and then join the control touch panel 20 to the transferring unit 30.

Other examples concerning the ways of separating the control touch panel 20 from the head unit 10 in this embodiment are given as follows. The magnetic attracting ways could use ordinary magnets or electromagnets. Using common magnet, the control touch panel 20 can be taken away to separate it from the transferring unit 30 by exerting an external force. Using an electromagnet, the control touch panel 20 can be separated from the transferring unit 30 by cutting off the electric power. The ways of cutting off electric power can be such as by operating a program menu of the control touch panel 20 or by pressing a button/switch of the head unit 10.

In addition, when the first magnetic module 35 and the second magnetic module 24 have only magnetic power, the second magnetic module 24 can further have an electrical connector 243, and the first magnetic module 35 further has an electrical connector 353. The electrical connector 243 of the second magnetic module 24 is electrically connected the electrical connector 353 of the first magnetic module 35 so as to provide electrical conduction and signal transmission functions. When the first magnetic module 35 and the second magnetic module 24 already have magnetic power, electrical conduction and signal transmission functions, they can omit the electrical connector 243 and the electrical connector 353, such as the commercial product Magconn™.

Moreover, this embodiment can further have an anti-eject unit as mentioned in the first embodiment, which can be disposed on the transferring unit 30, the second magnetic module 24, the front surface 11 of the head unit 10, or the back side 22 of the control touch panel 20. The structure and functions of the anti-eject unit are much like those of the first embodiment. In the case of having the anti-eject unit, when separating the control touch panel 20 from the transferring unit 30, we need to remove the structural fixing force of the anti-eject unit by, for example, pressing the eject button 125, and we also need to remove the magnetic force. In the case of using ordinary magnets, user can exert a force to take the control touch panel 20 down. In the case of using electromagnets, the control touch panel 20 can be separated from the transferring unit 30 by cutting off electric power. A convenient method is that pressing the eject button 125 can remove the structural fixing force of the anti-eject unit, cut off the electric power of the electromagnet, and retract the transferring unit 30 to its initial position if needed. The operating ways and types of the eject button 125 are similar to those of the first embodiment.

Further, the shape of the transferring unit 30 and that of the receiving hole 12 are not limited to a rectangle as shown in the figures. The numbers, positions and shapes of the magnetic parts are not limited to what are shown in the figures. Other parts of the head unit 10 can be similar to those in the first embodiment.

Let's discuss what happens after the control touch panel 20 is removed from the transferring unit 30. If the head unit 10 has no detector 110, the transferring unit 30 can move back to the initial position in the head unit 10 by pushing the transferring unit 30 or by the user pushing a button/switch on the head unit 10. If the head unit 10 has the detector 110 and the detector 110 detects that the control touch panel 20 has been removed, the detector 110 can provide a signal to the head unit 10 to retract the transferring unit 30 back to its initial position.

### Third Embodiment

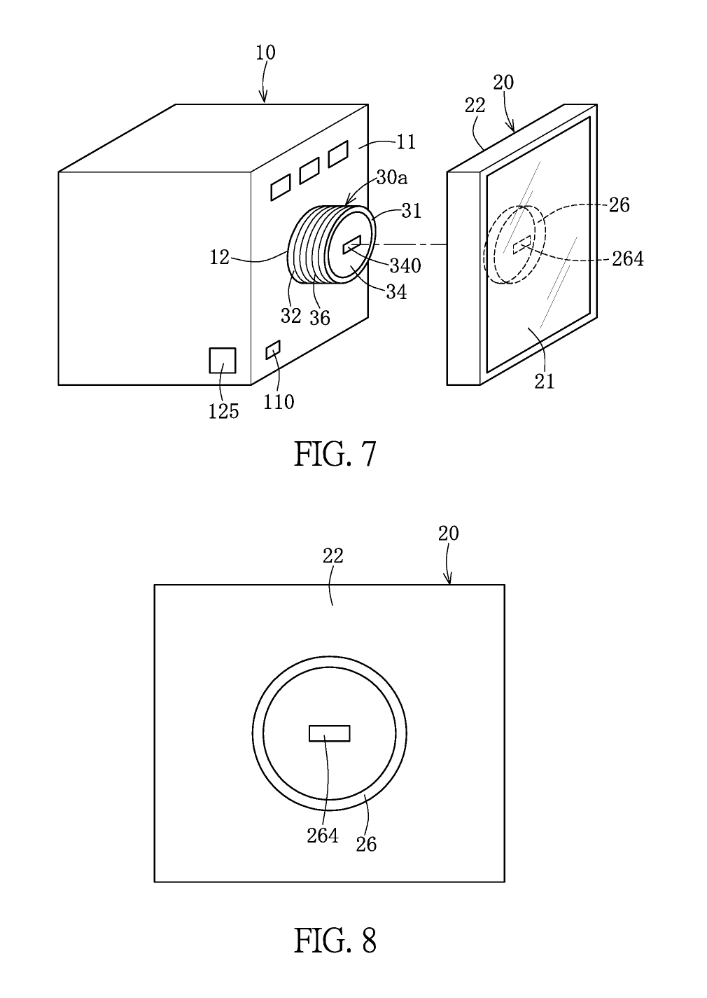

FIG. 7 and FIG. 8 are a perspective view of the vehicle head unit system of a third embodiment according to this instant disclosure and a rear view of control touch panel. The main difference from the above embodiments is that this embodiment uses the screw mechanism. The back side 22 of the control touch panel 20 has a screwing portion 26, and the first end 31 of the transferring unit 30a is connected to the screwing portion 26 of the control touch panel 20 in a screwing manner. The transferring unit 30a has a central fixed portion 34, and a screwing rotator 36 disposed at the periphery of the central fixed portion 34. The central fixed portion 34 has the electrical connector 340, and the screwing portion 26 of the control touch panel 20 has an electrical connector 264.

Refer to FIG. 8. The head unit 10 has a driving unit (not shown) to drive the screwing rotator 36 of the transferring unit 30a to rotate to mate the screwing portion 26 of the back side 22 of the control touch panel 20. When the screwing rotator 36 is rotating, the central fixed portion 34 keeps still. The driving unit can be mechanical, meaning a user must keep manually driving the driving unit to rotate the screwing rotator 36, or electrical, meaning the user presses a button/switch to activate rotating the screwing rotator 36, or a mixture of both. After the screwing is finished, the electrical connector 340 is connected to the electrical connector 264 to provide connections of electric power and data signals.

Further, the shape of the receiving hole 12 should correspond with that of the transferring unit 30a. The head unit 10 can have a mechanism to drive the transferring unit 30a out or back to the receiving hole 12. In this embodiment, the head unit 10 could have a detector 110 on the front surface 11. When the control touch panel 20 is detected, the screwing rotator 36 of the transferring unit 30a is driven to rotate and mate the screwing portion 26 of the control touch panel 20. Similar to the other embodiments, the head unit 10 could have an eject button 125. When the eject button 125 is pressed, the screwing rotator 36 is ejected from the screwing portion 26 of the control touch panel 20. If an anti-eject mechanism exists, the eject button 125 can also make the anti-eject mechanism retract and not work. Therefore, the control touch panel 20 can be separated from the transferring unit 30a. Alternatively, it can provide a set of steps on the control touch panel 20 to separate the control touch panel 20 and the transferring unit 30a such as “homepage”->“setup” ->“eject” on the control touch panel. The operating ways and types of the eject button 125 are similar to those of the above embodiments.

In addition, there are several cases when the user wants to combine the control touch panel 20 with the head unit 10. In the first example, the original position of the transferring unit 30a allows the user to combine the control touch panel 20 with the head unit 10. In this case, the user can directly put the control touch panel 20 on the transferring unit 30a. In the second example, the original position of the transferring unit 30a does not allow the user to combine the control touch panel 20 with the head unit 10. In this case, the user would need to move the transferring unit 30a out or use a button/switch of the head unit 10 so that the transferring unit 30a is extended out. Then, the user can put the control touch panel 20 on the transferring unit 30a. In the third example, the head unit 10 is equipped with the detector 110. When the control touch panel 20 is approaching the detector 110, the control touch panel 20 is detected by the detector 110, and then the transferring unit 30a is driven to a position where it is able to join the control touch panel 20 and the head unit 10. Then, the user can put the control touch panel 20 on the transferring unit 30a.

Moreover, if the head unit 10 has no detector 110, the user aligns the screwing portion 26 of the control touch panel 20 with the screwing rotator 36 of the transferring unit 30a and activates the screwing rotator 36 by a button or switch to rotate and connect with the screwing portion 26. After they are done mating, the screwing rotator 36 automatically stops rotating. If the head unit 10 has the detector 110, user aligns the screwing portion 26 of the control touch panel 20 with the screwing rotator 36 of the transferring unit 30a, and after the detector 110 detects the control touch panel 20, it automatically rotates the screwing rotator 36 to connect to the screwing portion 26. After they are fixed, the screwing rotator 36 automatically stops rotating.

When the control touch panel 20 has been taken away from the transferring unit 30a, and the head unit 10 is without the detector 110, the user can push the transferring unit 30a or press a button/switch of the head unit 10 so that the transferring unit 30a moves back to the original position in the head unit 10. If the head unit 10 is equipped with the detector 110, and the control touch panel 20 is no longer detected by the detector 110, the detector 110 can provide a signal to the head unit 10 so that the transferring unit 30a is retracted back to the original position. The detector 110 can be disposed at another place such as on the transferring unit 30a.

### Fourth Embodiment

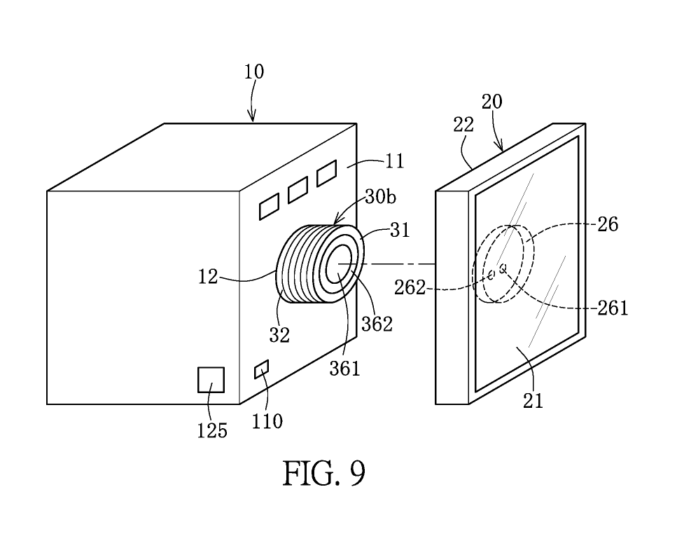

Refer to FIG. 9. This embodiment is different from the third embodiment in that the transferring unit 30b and the screwing portion 26 have a different connecting interface. The front surface of the transferring unit 30b has two ring-shaped annular conducting parts 361, 362 which are arranged as concentric circles, and their peripheries are electrical conducting parts. The screwing portion 26 has two contact electrodes 261, 262, which touch the annular conducting parts 361, 362 when the transferring unit 30b and the screwing portion 26 mate. The number of the annular conducting parts and that of the contact electrodes are not limited to two. When the transferring unit 30b is driven to rotate, the annular conducting parts 361, 362 also rotate. The transferring unit 30b can be connected to the screwing portion 26 of the control touch panel 20. After connection is finished, the contact electrodes 261, 262 contact the periphery of the annular conducting parts 361, 362 to provide connections of electrical power and data signals. Since the annular conducting parts 361, 362 are circular, the periphery of annular conducting parts 361, 362 can always successfully contact the contact electrodes 261, 262. Another way to provide connections of electrical power and data signals is that the first end 31 of the transferring unit 30b has a conductive part, and the screwing portion 26 also has a conductive part. When the transferring unit 30b is connected to the screwing portion 26, the two conductive parts touch each other to provide connections of electrical power and data signals.

Concerning other ways the control touch panel 20 is combined with or separated from the head unit 10, and other ways the transferring unit 30b retracts back to the original position in the head unit 10, refer to the above embodiments.

To sum up, this instant disclosure has benefits as follows. The vehicle head unit system of the instant disclosure provides many ways of the control touch panel 20 attaching to and detaching from the head unit 10 of the vehicle. The software of the vehicle head unit system can be conveniently updated by replacing the old control touch panel 20 with a new one. The control touch panel 20 can be separated from the head unit 10 and used independently.

For example, if the monitor of the current control touch panel 20 is only 7 inches, this instant disclosure can easily replace it with a control touch panel with a bigger screen. In addition, if a new control touch panel with more functions comes to market, the user can replace the old one with the new one.

The descriptions illustrated supra set forth simply the preferred embodiments of the instant disclosure; however, the characteristics of the instant disclosure are by no means restricted thereto. All changes, alterations, or modifications conveniently considered by those skilled in the art are deemed to be encompassed within the scope of the instant disclosure delineated by the following claims.

What is claimed is:

1. A vehicle head unit system, comprising:
a head unit, having a receiving hole,
a control touch panel, having an operating surface and a back side opposite to the operating surface, and
a transferring unit, having a first end and a second end, wherein the first end is connected to the back side of the control touch panel, and the second end is received in the receiving hole of the head unit.

2. The vehicle head unit system according to claim 1, wherein the head unit has a front surface, and the receiving hole is located at the front surface.

3. The vehicle head unit system according to claim 2, wherein when the control touch panel is attached to the head unit by the transferring unit, the control touch panel covers at least one part of the front surface of the head unit.

4. The vehicle head unit system according to claim 1, wherein the first end of the transferring unit is connected to the back side of the control touch panel;
wherein the transferring unit is connected to the back side of the control touch panel at an assembling angle for combining the control touch panel and the head unit;
wherein the transferring unit is connected to the back side of the control touch panel at a supporting angle for supporting the control touch panel on a plane when the control touch panel is separated from the head unit.

5. The vehicle head unit system according to claim 1, wherein the first end of the transferring unit is magnetically attached to the back side of the control touch panel.

6. The vehicle head unit system according to claim 5, wherein the transferring unit has a first magnetic module, wherein the back side of the control touch panel has a second magnetic module, wherein the first magnetic module is able to conduct electricity and transmit data signals to the second magnetic module.

7. The vehicle head unit system according to claim 1, wherein the back side of the control touch panel has a screwing portion, the first end of the transferring unit is screwed to the screwing portion of the control touch panel.

8. The vehicle head unit system according to claim 7, wherein the head unit has a driving unit to drive the transferring unit to rotate so as to screw to the back side of the control touch panel.

9. The vehicle head unit system according to claim 8, wherein the transferring unit has a central fixed portion and a screwing rotator, the screwing rotator is disposed at a periphery of the central fixed portion, the central fixed portion has an electrical connector, the screwing portion of the control touch panel has an electrical connector, wherein when the screwing rotator is screwed to the screwing portion, the electrical connector of the central fixed portion is connected to the electrical connector of the screwing portion.

10. The vehicle head unit system according to claim 8, wherein the transferring unit has at least one conducting part and the screwing portion has at least one contact electrode such that when the transferring unit is screwed to the screwing portion, the at least one contact electrode contacts the at least one conducting part.

11. The vehicle head unit system according to claim 1, wherein the head unit has an electrical connector in the receiving hole, the second end of the transferring unit has an electrical connector, wherein the first end of the transferring unit is electrically coupled to the control touch panel, the electrical connector of the head unit is electrically coupled to the electrical connector of the transferring unit.

12. The vehicle head unit system according to claim 1, further comprising an anti-eject mechanism disposed between the head unit and the transferring unit, wherein the anti-eject mechanism has a fixing part and an anti-eject unit, the anti-eject unit mates the fixing part.

13. The vehicle head unit system according to claim 12, wherein the head unit has an eject button to separate the fixing part from the anti-eject unit.

14. The vehicle head unit system according to claim 1, wherein a front surface of the head unit and a back side of the control touch panel has an anti-eject unit and a fixing part.

15. The vehicle head unit system according to claim 1, wherein the head unit has a detector for driving the transferring unit to connect to the control touch panel when the detector detects the presence of the control touch panel.
